(19) United States
(12) Patent Application Publication
(10) Pub. No.: US 2023/0185703 A1
(43) Pub. Date: Jun. 15, 2023

(54) AUTOMATIC PARSING AND PATH ANALYSIS METHOD FOR UNIT TEST CODE STRUCTURE

(71) Applicant: SOUTH CHINA UNIVERSITY OF TECHNOLOGY, Guangzhou (CN)

(72) Inventors: Fangqing LIU, Guangzhou (CN); Han HUANG, Guangzhou (CN); Xiao LING, Guangzhou (CN); Feng LIN, Guangzhou (CN); Jie CAO, Guangzhou (CN); Shaoyang ZHUANG, Guangzhou (CN); Zhifeng HAO, Guangzhou (CN)

(73) Assignee: SOUTH CHINA UNIVERSITY OF TECHNOLOGY, Guangzhou (CN)

(21) Appl. No.: 18/013,557

(22) PCT Filed: Oct. 28, 2021
(86) PCT No.: PCT/CN2021/127039

§ 371 Date: Dec. 29, 2022

(30) Foreign Application Priority Data
Nov. 13, 2020 (CN) 202011267313.5

(51) Int. Cl. G06F 11/36; G06F 8/41

(52) U.S. Cl. CPC G06F 11/3688; G06F 8/427

(57) ABSTRACT

Disclosed is an automatic parsing and path analysis method for a unit test code structure. The method comprises: acquiring compiled byte codes according to a language of a test program; traversing the complied byte codes, making instrumentation codes respectively in front of important statements, and acquiring node information and a small-segment path set (SSPS); analyzing the SSPS, replacing a part therein comprising nesting to obtain a SSPS excluding nesting as a basis, initializing a path table among the nodes, updating the path table by utilizing a depth-first algorithm, and obtaining path sets according to the path table; if all the path sets have been updated, returning to continuously update the path table; and outputting the acquired path sets and a program flowchart CFG obtained by analysis. The method above is capable of acquiring the path sets efficiently, thereby improving the capability of processing path analysis in actual software unit test.

### TECHNICAL FIELD

The present invention relates to the software testing field of computer software engineering, particularly to an automatic parsing and path analysis method for a unit test code structure.

### BACKGROUND

With social development and increasing application of artificial intelligence in IT field and the like, software products are more and more popular in life, thereby facilitating life in all aspects. Quality of software products becomes a concern focus day by day. To produce a software product with guaranteed quality is either one of important goals of producers or an important weight of IT enterprises to cope with market competition. As an important process in software development life, software testing is intended to ensure the quality of the software products. However, software testing incurs at least 50% of coat in software development. There are two modes for software testing: artificial participation and automation. Full-automatic testing has not yet been truly popularized in a software development process, and in most cases, testing still gives priority to artificial participation. However, the development degree of a technology decides the complexity of the software, and the testing difficulty and workload are increased therewith, but vigor of people is limited. This situation must be changed. Besides, there is a lot of frequently repeated work with low technical content in software testing, and if the work is completed by using a machine, the manpower consumption can be reduced greatly. Therefore, to test the software in an automatic mode is the optimum solution to solve the current problem. An excellent automatic testing solution can save a lot of manpower, material resources and financial resource, reduce resource consumption and improves enterprise benefit as well.

In order to reduce defects of the software as far as possible, it is necessary to generate infinite multiple test cases to measure the software. Regardless of greatness of scale of a program, exhaustion on its input is infeasible in the real world. Therefore, in the testing process, it is necessary to find an optimization method so as to reduce consumption of resources (for example, time, cost, manpower resource, system components and the like) without making a compromise on quality. The objective of optimization is to generate some valid test cases capable of covering a tested system with as short as possible time and as few as possible cost.

In existing methods, most dynamic methods used are specifically based on statement coverage or branch coverage, for example, a parallel program-oriented path analysis tool BPEL4WS(Yan J, Li Z, Yuan Y, et al. BPEL4WS unit testing: Test case generation using a concurrent path analysis approach[C]//2006 17th International Symposium on Software Reliability Engineering. IEEE, 2006: 75-84.)and a software unit testing tool EvoSuite (Fraser G, Arcuri A. Evosuite: automatic test suite generation for object-oriented software[C]//Proceedings of the 19th ACM SIGSOFT symposium and the 13th European conference on Foundations of software engineering. 2011: 416-419.).Although having functions of analyzing paths and generating test cases, coverage criteria of these tools have not implemented completed path coverage. BPEL4WS is based on simple path coverage, and EvoSuite can only analyze branch coverage and statement coverage. In all coverage types of soft testing, path coverage is the strongest coverage with a stronger error correcting capability, and can examine flaws and errors of the software more effectively. The first step to implement path coverage of unit test is to analyze the program so as to acquire a path needed to be covered, a program flow chart and other related information. However, most prior art needs artificial participation, which greatly improves the testing cost.

### SUMMARY

### Technical Problem

### Technical Solution for the Technical Problem

### Technical Solution

Aiming at deficiencies of existing test case generation software systems for software testing, the present invention provides an automatic parsing and path analysis method for a unit test code structure. The objective of the present invention is to design a reasonable automatic parsing and path analysis method for a unit test code to help software testing personnel be capable of rapidly obtaining a structure of a to-be-covered structure, path information and path coverage condition analysis of a test case under a path coverage criterion, so as to generate test cases by utilizing these information, thereby better detecting possible BUGs of a test program for repairing program bugs.

The objective of the present invention is at least realized by one of the technical solutions as follows:

an automatic parsing and path analysis method for a unit test code structure includes the following steps:

S1, using a compiler with a corresponding language to acquire compiled byte codes according to a language of a test program;

S2, traversing the complied byte codes, making instrumentation codes respectively in front of important statements, and acquiring node information and a small-segment path set;

S3, analyzing the small-segment path set acquired in S2 and replacing a part therein comprising nesting to obtain a small-segment path set excluding nesting;

S4, initializing a path table among the nodes based on the small-segment path set excluding nesting obtained in S3, updating the path table by utilizing a depth-first (DFS) algorithm, and obtaining path sets according to the path table;

S5, if not all the path sets are covered, namely, all the path sets have been updated, skipping to S6, and otherwise skipping to S4; and

S6, outputting the acquired path sets and a program flowchart CFG obtained by analysis.

further, in S2, the compiled byte codes are traversed, and during the traversing process, the node needed to be instrumented includes a beginning of a function, an end of a function, a common execute statement segment, a branch statement, a loop statement and a nested statement of a function or a class.

Further, when the corresponding node is searched, a predetermined class insertion function Data.add(temp) is used for implementing instrumentation of the node, where temp represents node information and a character string encoded by the node, and Data is a class where path information is stored; during a process of encoding each node of the path, a global variable N is set, an initial value of the global variable is set to be 0, the global variable is encoded and assigned to be N when a specific node is traversed every time, and then the value is updated as N=N+1;

the instrumentation statement is used for instrumentation of the byte codes when the beginning of the function, the end of the function and the branch statement and the loop statement are traversed, so as to insert the corresponding node information into a corresponding position; and

the branch statement and loop statement includes if, switch, for and while.

Further, in S2, preprocessing is performed while the compiled byte codes are traversed to acquire an instrumented node code and constraint expression information present in the branch statement, the loop statement and the function nesting, and meanwhile, variable information therein is recalled to find out an original input variable expression for the convenience of subsequent analysis of path feasibility.

Further, in S2, the instrumented nodes are stored when being traversed every time, and form small-segment paths between two nodes in pairs according to a traversal sequence, for example, the following program example:

do A;

if(true) do B;

else do C;

do D;

multiple small-segment paths: (A, B), (A, C), (B, D), (C, D) and the like would be formed respectively, where the nodes including the function nesting and class nesting replace the small-segment paths by using the function invoke labels invoke labels, for example, the following example codes:

do A;

method C( );//the function C is invoked here

do B;

multiple small-segment paths: (A, invoke.C)(invoke.C, B) would be formed for the convenience of subsequent replacement.

Further, in S3, based on the small-segment path set formed by the nodes in pairs acquired in S2, the small-segment path set is traversed to find out paths marked by the function invoke labels in the path set, the corresponding function path set is acquired by the labels, and the paths in the function path set are used for replacing the paths marked by the function invoke labels in the original path set, so as to form a small-segment path set without function nesting or class nesting. A pseudocode in S3 is as shown as follows:

```
for(path_1 in A path set)
  {
  If(path_1−>end point == invoke){
    acquire path set of the function B invoked by path_1−>end point;
    for(path_2 in B path set)
    {
      If(path_2−>starting point == start){
        replace path_1−>end point by path_2−>starting point;
        import other paths in the B path set;
      }
    }
  }
  If(path_1−>starting point == invoke){
    acquire path set of the function B invoked by path_1−>starting point;
    for(path_2 in B path set)
    {
      If(path_2−>end point == end){
        replace path_1−>starting point by path_2−>endpoint;
        import other paths in the B path set;
      }
    }
  }
} .
```

Further, in S4, the path table M between the nodes is initialized by utilizing set information of the small-segment path set excluding nesting acquired in S3, and the number of rows and the number of lines of the path table M both are the number of the nodes; then depth-first traversal is performed on the path table M according to a adjacency relation between the nodes by taking an initial node of the function as a node of the path by utilizing the DFS, the traversed nodes are recorded in the traversing process, and when a terminal node of the function is traversed, current transversal is finished, the recorded nodes subjected to the current traversal are taken out and are denoted as a full path, and then traversal is performed again to generate all the other full paths according to the same method. A pseudocoele in S4 is as shown as follows:

```
  for node in function node set
  {
    if node is start
    {
      push the node to stack;
    }
  }
  while the node stack is non-null
  {
    if the node at the top of the stack is end
    {
      store the nodes in the current stack and form a full path:
      pull the node at the top of the stack out of the stack:
    }
    else
    {
      traverse the path table to acquire the first non-accessed node from
left to right in a row where the node at the top of the stack on the path
table is located with data of 1:
      if the node is available, push the node to stack, and meanwhile, set
the node to be accessed:
    }
  }
```

Further, the path table M represents the adjacency relation between the path nodes, each row and each line represent whether there is a path between the nodes, the leftmost row represents the node of the starting point of the path, the uppermost line represents the node of an end point of the path, and with respect to a cell, if there is a path at the node corresponding to the line of the cell to arrive at the node corresponding to the line of the cell, the value of the cell is set to be 1 and otherwise, the value of the cell is set to be 0.

Further, in S5, as a result of the loop statement, the number of the paths of the unit program might be increased abruptly, and the number of paths to be finally covered could not be determined. By adopting a K-loop loop path judging method, i.e., the number of all maximum loops is K by default, the path set to be covered is judged, for example:

While (a<10)

{print(“a”); }

By assuming that K=2, 1 represents incycle and 0 represents non-incycle, the path segment has four possibilities: 00, 01, 10 and 11. Meanwhile, the constraint expression of the path is analyzed by utilizing the symbolic execution technology, so that the feasibility of the path is judged and the infeasible path is removed, for example, the path like (a==0&&a==1) which would cause no solution of the constraint expression, and the final unit program path set to be covered is obtained by optimization.

Further, in S6, after acquiring all path coding information in S4 and S5, a tree diagram of the nodes would be constructed by virtue of statistical analysis on path node information, so as to obtain a full flowchart of the test unit program, specifically including:

first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

The automatic parsing and path analysis method for a unit test code structure provided by the present invention includes: first, compiling a test unit code to acquire byte codes; then traversing the byte codes to determine contents of a tested program such as judgment, loop branch and function nesting, performing instrumentation of labels in the program and acquiring symbolic codes at branch nodes and information such as other data reference and calculation expressions as well, and acquiring information of nodes connected in pairs between label nodes while traversing the byte codes to obtain a small-segment path set of the tested program; and then acquiring the full small-segment path set by replacing path information such as potential nesting nodes, then initializing a path table by using the small-segment path set, obtaining the full path table by utilizing depth-first search algorithm, and finally, analyzing a constraint expression with the feasible path by combining path branch information based on the acquired constraint expression, removing infeasible paths, and outputting the final path set and acquiring a final program flowchart CFG by means of a path node synthetic algorithm.

### Beneficial Effects of the Present Invention

### Beneficial Effects

Compared with the prior art, the present invention has the following advantages and technical effects:

With respect to software related to software unit testing and path analysis, most software in the market use simple random rules or static symbol execution modes. The former is too simple. The latter is poor in ability to solve complex test problems. The present invention use the mode of automatically inserting instrumentation codes, compiling and analyzing the instrumentation codes so as to acquire a path set efficiently, thereby greatly improving the capability of processing path analysis in an actual software unit test. Second, path coverage serves as a stronger coverage criterion, and test cases found by corresponding path coverage criterion has a higher error correcting capability. An existing program path analysis tool has not considered feasibility of the path on the one hand and is absent to acquire branch information of the program, thereby not providing sufficient information for generating test cases for path coverage subsequently. By way of performing automatic instrumentation of token codes and analyzing the compiled byte codes, the present invention can acquire information in the nesting function in the tested function so as to form a full path, and eliminate those redundant paths which cannot be covered by utilizing the acquired constraint expression of the path, thereby reducing the pressure of subsequently generating the test cases for path coverage. Meanwhile, the method further can determine the coverage path of the test cases in real time and provide visual flowchart information for test personnel. The related method of this application is relative convenient, the test personnel needs not to understand laws such as logic of the tested program deeply, the method is of very high usability, and the test personnel performs simple operations according to the method provided by the present invention. The method has a wide application space.

The technical means used in the present invention can realize automatic parsing and path analysis work for the actual engineering code unit program without artificial participation. The method can perform instrumentation on the program automatically to analyze the program structure so as to acquire the to-be-covered path information on the one hand, and can further analyze the path covered by the test cases automatically and provide important information such as an evaluation function to a path coverage algorithm on the other hand, thereby significantly improving the efficiency of generating the test cases for path coverage.

### BRIEF DESCRIPTION OF DRAWINGS

### Description of Drawings

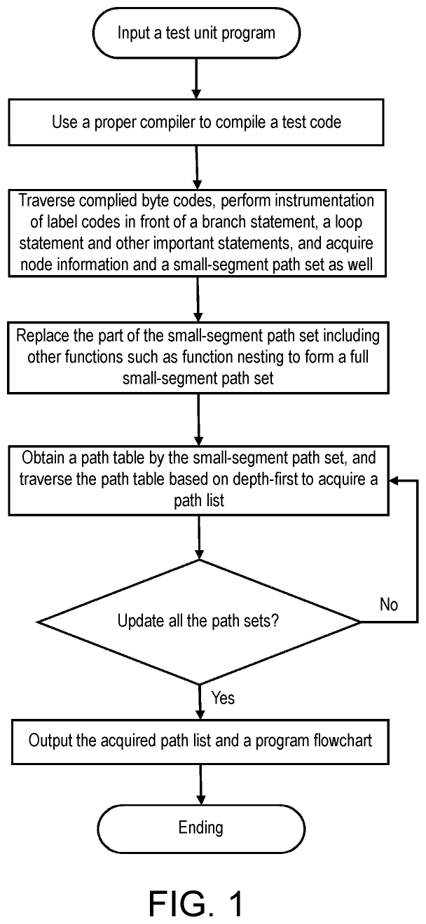

FIG. 1 is a flow chart of an automatic parsing and path analysis method for a unit test code structure in an embodiment of the present invention.

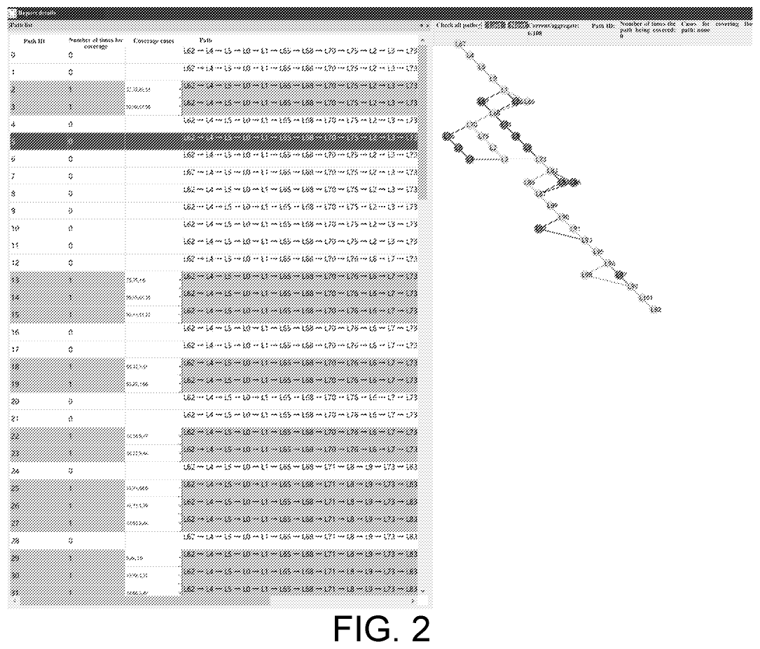

FIG. 2 is a schematic diagram of a visual result of a path set and a flow chart in an embodiment of the present invention.

### EMBODIMENTS OF THE INVENTION

### Detailed Description of Embodiments

Implementation modes are further described below in combination with the accompanying drawings and embodiments, but implementation the present invention is not limited thereto.

Embodiments:

In the embodiment, a segment of Java example codes is taken as an example (test of a sample code Single class is a to-be-tested function): package com.moi.test.sample;

```
public class Single {
  public static void test(int a, int b) {
    boolean n = true;
    Computer computer = new Computer(a, b);
    if(n == true){
      System.out.println(4);
    }
    if(n != true){
      System.out.println(4);
    }
    for(int i =0;i<6;i++){
      computer.div( );
    }
    a=a+b;
    computer.sub( );
  }
}
A dependent class is Computer, a code of which is as follows:
package com.moi.test.sample;
public class Computer {
  private int a;
  private int b;
  public Computer(int a, int b) {
    this.a = a;
    this.b = b;
  }
  public int add( ) {
    return a + b;
  }
  public int sub( ) {
    return a − b;
  }
  public int div( ) {
    if (b != 0) {
      return a / b;
    } else {
      return −1;
    }
  }
  public int getA( ) {
    return a;
  }
  public void setA(int a) {
    this.a = a;
  }
  public int getB( ) {
    return b;
  }
  public void setB(int b) {
    this.b = b;
  }
}
```

An automatic parsing and path analysis method for a unit test code structure shown in FIG. 1 includes the following steps:

S1, a compiler with a corresponding language is used to acquire compiled byte codes according to a language of a test program;

S2, the complied byte codes are traversed, instrumentation codes are made respectively in front of important statements, and x node information and a small-segment path set are acquired;

the compiled byte codes are traversed, and during the traversing process, the node needed to be instrumented includes a beginning of a function, an end of a function, a common execute statement segment, a branch statement, a loop statement and a nested statement of a function or a class;

when the corresponding node is searched, a predetermined class insertion function Data.add(temp) is used for implementing instrumentation of the node, where temp represents node information and a character string encoded by the node, and Data is a class where path information is stored; during a process of encoding each node of the path, a global variable N is set, an initial value of the global variable is set to be 0, the global variable is encoded and assigned to be N when a specific node is traversed every time, and then the value is updated as N=N+1;

the instrumentation statement is used for instrumentation of the byte codes when the beginning of the function, the end of the function and the branch statement and the loop statement are traversed, so as to insert the corresponding node information into a corresponding position; and

the branch statement and loop statement includes if, switch, for and while.

Preprocessing is performed while the compiled byte codes are traversed to acquire an instrumented node code and constraint expression information present in the branch statement, the loop statement and the function nesting, and meanwhile, variable information therein is recalled to find out an original input variable expression for the convenience of subsequent analysis of path feasibility.

The instrumented nodes are stored when being traversed every time, and form small-segment paths between two nodes in pairs according to a traversal sequence, where the nodes including function nesting and class nesting are marked by using function invoke labels to replace the small-segment path for the convenience of subsequent replacement.

In the embodiment, the compiled to-be-tested code is traversed by using an asm library to acquire instrumentation of the code and the small-segment path set, where the code after instrumentation is as follows:

com/moi/test/sample/Single.init:START is a node information expression, com/moi/test/sample is a package name of the class, Single corresponds to the class name, init corresponds to the name of the function where the node is, the label of the node is after “:”, START represents the initial position of the function, END represents an end position of the function, !L1502635287 represents the value of corresponding LABEL in the byte codes, and specific values are determined by the byte codes.

```
package com.moi.test.sample;
import com.moi.japaco.Data;
import com.moi.japaco.Judge;
public class Single {
  public Single( ) {
    Data.array.add(“com/moi/test/sample/Single.init:START”);
    super( );
    Data.array.add(“com/moi/test/sample/Single.init:END”);
  }
  public static void test(int var0, int var1) {
    Data.array.add(“com/moi/test/sample/Single.test:START”);
    byte var2 = 1;
    Computer var3 = new Computer(var0, var1);
    Judge.if_setValue(var2, 1, “com/moi/test/sample/Single.test:I0”);
    if (var2 == 1) {
      Data.array.add(“com/moi/test/sample/Single.test:!L394721749”);
      System.out.println(4);
    }
    Data.array.add(“com/moi/test/sample/Single.test:L394721749”);
    Judge.if_setValue(var2, 1, “com/moi/test/sample/Single.test:I1”);
    if (var2 != 1) {
      Data.array.add(“com/moi/test/sample/Single.test:!L1884122755”);
      System.out.println(4);
    }
    Data.array.add(“com/moi/test/sample/Single.test:L1884122755”);
    int var4 = 0;
    while(true) {
      Data.array.add(“com/moi/test/sample/Single.test:L1134612201”);
      Judge.if_setValue(var4, 6, “com/moi/test/sample/Single.test:I2”);
      if (var4 >= 6) {
        Data.array.add(“com/moi/test/sample/Single.test:L246550802”);
        int var10000 = var0 + var1;
        var3.sub( );
        Data.array.add(“com/moi/test/sample/Single.test:END”);
        return;
      }
      Data.array.add(“com/moi/test/sample/Single.test:!L246550802”);
      var3.div( );
      ++var4;
    }
  }
}
```

S3, the small-segment path set acquired in S2 is analyzed and a part therein including nesting is replaced to obtain a small-segment path set excluding nesting;

based on the small-segment path set formed by the nodes in pairs acquired in S2, the small-segment path set is traversed to find out paths marked by the function invoke labels in the path set, the corresponding function path set is acquired by the labels, and the paths in the function path set are used for replacing the paths marked by the function invoke labels in the original path set, so as to form a small-segment path set without function nesting or class nesting.

In the embodiment, (var2==1) can be acquired as a condition that the branch enters the first if branch, and the condition to enter the else branch is (var2!=1).

In the embodiment, when the to-be-tested code is traversed and instrumented by using the asm library, the small-segment path set formed by the nodes in pairs in the to-be-tested function would be acquired according to a source code logic as follows: (the test function in Single class is taken as the to-be-tested function)

Single.test:START:L747->Computer.init:#INVOKE#:I748

Computer.init:#INVOKE#:I748->Single.test:L292917034:L749

Computer.init:#INVOKE#:I748->Single.test:!L292917034:L750

Single.test:!L292917034:L750->Single.test:L292917034:L749

Single.test:L292917034:L749->Single.test:L242355057:L751

Single.test:L242355057:L751->Single.test:L455538610:L752

Single.test:L242355057:L751->Single.test:!L455538610:L753

Single.test:!L455538610:L753->Computer.div:#INVOKE#:I754

Computer.div:#INVOKE#:I754->Single.test:L242355057:L751

Single.test:L455538610:L752->Computer.sub:#INVOKE#:I755

Computer.sub:#INVOKE#:I755->Single.test:END:L758

It can be seen from the path set above that a part of paths has #INVOKE# labels, for example:

Single.test:L455538610:L752->Computer.sub:#INVOKE#:I755

Computer.sub:#INVOKE#:I755->Single.test:END:L758

The left half part of the path 1 represents the nodes of the to-be-tested function Single.test and Computer.sub in the right half part with the #INVOKE# label is an external function invoked in the Single.test. Therefore, the small-segment path set of the invoked function is acquired first:

Computer.sub:START:L849->Computer.sub:END:L850

After the small-segment path set of the invoked function is acquired, the INVOKE label at the right end in the original function path set is replaced by the starting label START of the invoked function, and the INVOKE label at the left end in the original function path set is replaced by the end label END of the invoked function:

Single.test:L455538610:L752->Computer.sub:START:L849

Computer.sub:END:L850->Single.test:END:L758

The path set of the invoked function is integrated into the path set of the to-be-tested function, so as to obtain the path set without function nesting.

S4, a path table among the nodes is initialized based on the small-segment path set excluding nesting obtained in S3, the path table is updated by utilizing a depth-first (DFS) algorithm, and path sets are obtained according to the path table;

The path table M among the initialized nodes is initialized by utilizing integration information of the small-segment path set excluding nesting in S3, where the numbers of rows and columns of the path table M both are the numbers of the nodes;

the path table M represents the adjacency relation between the path nodes, each row and each line represent whether there is a path between the nodes, the leftmost row represents the node of the starting point of the path, the uppermost line represents the node of an end point of the path, and with respect to a cell, if there is a path at the node corresponding to the line of the cell to arrive at the node corresponding to the line of the cell, the value of the cell is set to be 1 and otherwise, the value of the cell is set to be 0.

then depth-first traversal is performed on the path table M according to a adjacency relation between the nodes by taking an initial node of the function as a node of the path by utilizing the DFS, the traversed nodes are recorded in the traversing process, and when a terminal node of the function is traversed, current transversal is finished, the recorded nodes subjected to the current traversal are taken out and are denoted as a full path, and then traversal is performed again to generate all the other full paths according to the same method.

In the embodiment, a path table can be obtained by removing the nested path set, and a node information mapping table shown in table 1 is made first hereto.

Table 1 Node information mapping table

TABLE 1

| | |
|---|---|
| Single.test:START:L747 | L0 |
| Computer.init:START:L701 | L1 |
| Computer.init:END:L702 | L2 |
| Single.test:!1L292917034:L750 | L3 |
| Single.test:L292917034:L749 | L4 |
| Single.test:L242355057:L751 | L5 |
| Single.test:!L455538610:L753 | L6 |
| Single.test:L455538610:L752 | L7 |
| Computer.div:START:L707 | L8 |
| Computer.div:END:L710 | L9 |
| Computer.sub:START:L705 | L10 |
| Computer.sub:END:L706 | L11 |
| Single.test:END:L758 | L12 |

Through the node information mapping table, the corresponding path table can be made as shown in table 2. If there is a path Lx->Ly, the value of [Lx, Ly] is made to be 1.

TABLE 2
Path table

| | | | | | | | | | | | | |
|---|---|---|---|---|---|---|---|---|---|---|---|---|
| L0 | L1 | L2 | L3 | L4 | L5 | L6 | L7 | L8 | L9 | L10 | L11 | L12 |

| | | | | | | | | | | | | |
|---|---|---|---|---|---|---|---|---|---|---|---|---|
| L0 | 1 | | | | | | | | | | | |
| L1 | | 1 | | | | | | | | | | |
| L2 | | | 1 | 1 | | | | | | | | |
| L3 | | | | 1 | | | | | | | | |
| L4 | | | | | 1 | | | | | | | |
| L5 | | | | | | 1 | 1 | | | | | |
| L6 | | | | | | | | 1 | | | | |
| L7 | | | | | | | | | | 1 | | |
| L8 | | | | | | | | | 1 | | | |
| L9 | | | | | 1 | | | | | | | |
| L10 | | | | | | | | | | | 1 | |
| L11 | | | | | | | | | | | | 1 |
| L12 | | | | | | | | | | | | |

Calculated by the algorithm, the path can be obtained as follows:

Single.test:START:L819->Computer.init:START:L773->Computer.init:END:L774->Single.test:L394721749:L821->Single.test:L1884122755:L823->Single.test:L1134612201:L825->Single.test:L246550802:L826->Computer.sub:START:L777->Computer.sub:END:L778->Single.test:END:L830->

Single.test:START:L819->Computer.init:START:L773->Computer.init:END:L774->Single.test:L394721749:L821->Single.test:!L1884122755:L824->Single.test:L1884122755:L823->Single.test:L1134612201:L825->Single.test:L246550802:L826->Computer.sub:START:L777->Computer.sub:END:L778->Single.test:END:L830->

. . . (totally 28 paths can be obtained, and contents of the paths are omitted)

S5, if not all the path sets are covered, namely, all the path sets have been updated, it is skipped to S6, and otherwise it is skipped to S4;

as a result of the loop statement, the number of the paths of the unit program might be increased abruptly, and the number of paths to be finally covered could not be determined. By adopting a K-loop loop path judging method, i.e., the number of all maximum loops is K by default, the path set to be covered is judged, for example:

While (a<10)

{print(“a”); }

It is assumed that K=2, 1 represents incycle and 0 represents non-incycle, the path segment has four possibilities: 00, 01, 10 and 11. Meanwhile, the constraint expression of the path is analyzed by utilizing the symbolic execution technology, so that the feasibility of the path is judged and the infeasible path is removed, for example, the path like (a==0&&a==1) which would cause no solution of the constraint expression, and the final unit program path set to be covered is obtained by optimization.

In the embodiment, the constraint expression of each path is analyzed. The paths which cannot be solved by the constraint expressions are removed, and meanwhile, a condition that a lot of paths are generated by loop statement is alleviated by using the K-loop loop path judgment method. It is shown as follows:

```
if (var2 == 1) {
    Data.array.add(“com/moi/test/sample/Single.test:!L394721749”);
    System.out.println(4);
  }
  Data.array.add(“com/moi/test/sample/Single.test:L394721749”);
  Judge.if_setValue(var2, 1, “com/moi/test/sample/Single.test:I1”);
      if (var2 != 1) {
    Data.array.add(“com/moi/test/sample/Single.test:!L1884122755”);
    System.out.println(4);
  }
```

Single.test:!L394721749 and Single.test:!L1884122755 could not appear in a same path, but there is a path in the path list to cover the two points at the same time, for example, the following segment in the path 28:

Single.test:!L394721749:L822->Single.test:L394721749:L821->Single.test:!L1884122 755:L824->Single.test:L1884122755:L823

Therefore, the path 28 does not conform with the code logic and should be eliminated.

S6, the acquired path sets and a program flowchart CFG obtained by analysis are outputted;

after acquiring all path coding information in S4 and S5, a tree diagram of the nodes would be constructed by virtue of statistical analysis on path node information, so as to obtain a full flowchart of the test unit program, specifically including:

first, the most frequent pre-node in front of each node is found, and the pre-node of the node is taken as a father node of the node in the flowchart; and according to the law to construct a tree structure, all nodes that are not placed from the initial node are traversed, so as to acquire flowchart information, as shown in FIG. 2.

It can be seen from the result of the embodiment, the present invention can find out the path set of the tested program, generate the corresponding flowchart and visualize the result.

1. An automatic parsing and path analysis method for a unit test code structure, comprising the following steps:
S1, using a compiler with a corresponding language to acquire compiled byte codes according to a language of a test program;
S2, traversing the complied byte codes, making instrumentation codes respectively in front of important statements, and acquiring node information and a small-segment path set;
S3, analyzing the small-segment path set acquired in S2 and replacing a part therein comprising nesting to obtain a small-segment path set excluding nesting;
S4, initializing a path table among the nodes based on the small-segment path set excluding nesting obtained in S3, updating the path table by utilizing a depth-first (DFS) algorithm, and obtaining path sets according to the path table;
S5, if not all the path sets are covered, namely, all the path sets have been updated, skipping to S6, and otherwise skipping to S4; and
S6, outputting the acquired path sets and a program flowchart CFG obtained by analysis.

2. The automatic parsing and path analysis method for a unit test code structure according to claim 1, wherein in S2, the compiled byte codes are traversed, and during the traversing process, the node needed to be instrumented includes a beginning of a function, an end of a function, a common execute statement segment, a branch statement, a loop statement and a nested statement of a function or a class.

3. The automatic parsing and path analysis method for a unit test code structure according to claim 2, wherein when the corresponding node is searched, a predetermined class insertion function Data.add(temp) is used for implementing instrumentation of the node, wherein temp represents node information and a character string encoded by the node, and Data is a class where path information is stored; during a process of encoding each node of the path, a global variable N is set, an initial value of the global variable is set to be 0, the global variable is encoded and assigned to be N when a specific node is traversed every time, and then the value is updated as N=N+1;
the instrumentation statement is used for instrumentation of the byte codes when the beginning of the function, the end of the function and the branch statement and the loop statement are traversed, so as to insert the corresponding node information into a corresponding position; and
the branch statement and loop statement comprise if, switch, for and while.

4. The automatic parsing and path analysis method for a unit test code structure according to claim 3, wherein in S2, preprocessing is performed while the compiled byte codes are traversed to acquire an instrumented node code and constraint expression information present in the branch statement, the loop statement and the function nesting, and meanwhile, variable information therein is recalled to find out an original input variable expression for the convenience of subsequent analysis of path feasibility.

5. The automatic parsing and path analysis method for a unit test code structure according to claim 4, wherein in S2, the instrumented nodes are stored when being traversed every time, and form small-segment paths between two nodes in pairs according to a traversal sequence, wherein the nodes including function nesting and class nesting are marked by using function invoke labels to replace the small-segment path for the convenience of subsequent replacement.

6. The automatic parsing and path analysis method for a unit test code structure according to claim 5, wherein in S3, based on the small-segment path set formed by the nodes in pairs acquired in S2, the small-segment path set is traversed to find out paths marked by the function invoke labels in the path set, the corresponding function path set is acquired by the labels, and the paths in the function path set are used for replacing the paths marked by the function invoke labels in the original path set, so as to form a small-segment path set without function nesting or class nesting.

7. The automatic parsing and path analysis method for a unit test code structure according to claim 6, wherein in S4, the path table M between the nodes is initialized by utilizing set information of the small-segment path set excluding nesting acquired in S3, and the number of rows and the number of lines of the path table M both are the number of the nodes; then depth-first traversal is performed on the path table M according to a adjacency relation between the nodes by taking an initial node of the function as a node of the path by utilizing the DFS, the traversed nodes are recorded in the traversing process, and when a terminal node of the function is traversed, current transversal is finished, the recorded nodes subjected to the current traversal are taken out and are denoted as a full path, and then traversal is performed again to generate all the other full paths according to the same method.

8. The automatic parsing and path analysis method for a unit test code structure according to claim 7, wherein the path table M represents the adjacency relation between the path nodes, each row and each line represent whether there is a path between the nodes, the leftmost row represents the node of the starting point of the path, the uppermost line represents the node of an end point of the path, and with respect to a cell, if there is a path at the node corresponding to the line of the cell to arrive at the node corresponding to the line of the cell, the value of the cell is set to be 1 and otherwise, the value of the cell is set to be 0.

9. The automatic parsing and path analysis method for a unit test code structure according to claim 7, wherein in S5, a path set needed to be covered is determined by adopting a loop path judgment method of K-loop, i.e., the maximum loop numbers of times of all loops are K times by default; and meanwhile, the constraint expression of the path is analyzed by utilizing a symbolic execution technology, so as to determine feasibility of the path and to remove infeasible paths, thereby obtaining, by optimization, a final unit program path set needed to be covered.

10. The automatic parsing and path analysis method for a unit test code structure according to claim 1, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

11. The automatic parsing and path analysis method for a unit test code structure according to claim 2, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

12. The automatic parsing and path analysis method for a unit test code structure according to claim 3, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

13. The automatic parsing and path analysis method for a unit test code structure according to claim 4, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

14. The automatic parsing and path analysis method for a unit test code structure according to claim 5, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

15. The automatic parsing and path analysis method for a unit test code structure according to claim 6, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

16. The automatic parsing and path analysis method for a unit test code structure according to claim 7, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

17. The automatic parsing and path analysis method for a unit test code structure according to claim 8, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.

18. The automatic parsing and path analysis method for a unit test code structure according to claim 9, wherein in S6, after acquiring all path coding information in S4 and S5, a tree diagram of the nodes would be constructed by virtue of statistical analysis on path node information, so as to obtain a full flowchart of the test unit program, specifically comprising:
first, finding out the most frequent pre-node in front of each node, and taking the pre-node of the node as a father node of the node in the flowchart; and traversing, according to the law to construct a tree structure, all nodes that are not placed from the initial node, so as to acquire flowchart information.
